(19) United States
(12) Patent Application Publication
(10) Pub. No.: US 2008/0026126 A1
(43) Pub. Date: Jan. 31, 2008

(54) WHIPPING CREAM COMPRISING TOFU PUREE

(75) Inventor: Manabu Suzuki, Zama-shi (JP)

Correspondence Address: WOOD, HERRON & EVANS, LLP, 2700 CAREW TOWER, 441 VINE STREET, CINCINNATI, OH, 45202, US

(73) Assignee: MORINAGA MILK INDUSTRY CO., LTD., Tokyo (JP)

(21) Appl. No.: 11/743,960

(22) Filed: May 3, 2007

(30) Foreign Application Priority Data
Jul. 25, 2006 (JP) 2006-201993

(51) Int. Cl. A23L 1/19

(52) U.S. Cl. 426/572

(57) ABSTRACT

A whipping cream contains: an oil and fat composition in an amount of 20 to 50% by mass; a tofu puree in an amount of 1 to 8% by mass as a solid content of soybeans; and water in an amount of 0 to 73% by mass; wherein the oil and fat composition contains: an oil and fat; and an emulsifier in an amount of 0.5 to 5% by mass with respect to a mass of the oil and fat, and the tofu puree contains particles and has physical and chemical properties of: (a) viscosity of 20 to 3,000 mPa·s; (b) dynamic storage modulus of 0.2 to 600 Pa; (c) dynamic loss modulus of 0.2 to 250 Pa; and (d) an average particle size of the particles of 2 to 15 μm and a 90% particle size thereof of 35 μm or smaller.

### BACKGROUND OF THE INVENTION

1. Field of the Invention

The present invention relates to a whipping cream containing a tofu puree.

Priority is claimed on Japanese Patent Application No. 2006-201993, filed Jul. 25, 2006, the content of which is incorporated herein by reference.

2. Description of the Related Art

The use of soybeans in various foods has become a recent trend, aiming at health, because soybeans contain not only an abundance of good-quality protein, but also bioactive substances such as isoflavone, saponin, lecithin, tocopherol, linoleic acid (derived from soybean oil), and the like, without containing cholesterol. In the prior art, as a whipping cream containing a soybean processed food such as soymilk, or the like, the following has been disclosed:

(1) soymilk whipping cream containing 30 to 50% by mass of oil in addition to soymilk (see Japanese Examined Patent Application, Second Publication No. H4-64660 (Patent Document 1)).

Moreover, as a method for producing a tofu paste or the like, which is utilized for producing a soybean processed food or the like, the following have been disclosed:

(1) a method where tofu is made into a paste-like material using a silent cutter or the like, followed by being frozen (see Japanese Unexamined Patent Application, First Publication No. H6-46784 (Patent Document 2));
(2) a method where a coagulant is added to soymilk, and then the obtained coagulated soymilk is dehydrated, followed by processing the dehydrated material into a paste using a high-speed cutter or the like (see Japanese Examined Patent Application, Second Publication No. H8-29059 (Patent Document 3));
(3) a method where a coagulant is added to soymilk, followed by processing the coagulated soymilk into a paste using a homogenizer (Japanese Unexamined Patent Application, First Publication No. S59-71641 (Patent Document 4)); and
(4) a method for producing a tofu puree having specific physical and chemical properties (see Japanese Patent Publication No. 3327541 (Patent Document 5)).

However, the whipping cream disclosed in Patent Document 1 is lacking in rich flavor, and maintains a green flavor, which is unique to soymilk. When an oil is contained in an amount of less than 30% by mass, the obtained cream becomes soft and creates problems in terms of decorative features and shape retainability after being whipped.

Moreover, there is no case in the prior arts where coagulated soymilk produced by adding a coagulant to so-called soymilk, such as tofu, tofu paste, or the like, be used as a soybean processed food available for preparing a conventional whipping cream. Also, there is no case in the prior arts where a technique for processing coagulated soymilk, such as tofu, disclosed in the method in Patent Documents 2 to 5, into a paste is applied to produce a whipping cream.

### SUMMARY OF THE INVENTION

The present invention relates to a whipping cream containing: an oil and fat composition in an amount of 20 to 50% by mass; a tofu puree in an amount of 1 to 8% by mass as a solid content of soybeans; and water in an amount of 0 to 73% by mass; wherein the oil and fat composition contains: an oil and fat; and an emulsifier in an amount of 0.5 to 5% by mass with respect to the mass of the oil and fat, and the tofu puree contains particles and has physical and chemical properties of: (a) viscosity of 20 to 3,000 mPa·s; (b) dynamic storage modulus of 0.2 to 600 Pa; (c) dynamic loss modulus of 0.2 to 250 Pa; and (d) an average particle size of the particles of 2 to 15 μm and a 90% particle size thereof of 35 μm or smaller.

### BRIEF DESCRIPTION OF THE DRAWINGS

FIG. 1 is a drawing illustrating an embodiment of a device for manufacturing a tofu puree to be contained in a whipping cream according to the present invention.

### DEFINITION OF SYMBOLS

1. Raw material tank
2. Metering pump
3. Heating means (plate heater)
4. Heat source
5. Temperature controller
6. Holding pipe
7. Coagulant supply means
8. Coagulant tank
9. Metering pump
10. First emulsification dispersion means (MILDER/trademark)
11. Cooling means (plate cooler)
12. Refrigerant supply means
13. Temperature controller
14. Second emulsification dispersion means

### DETAILED DESCRIPTION OF THE INVENTION

The present invention has been achieved in view of the above-mentioned circumstances, and has as the object thereof to provide a whipping cream excellent in whippability, decoration suitability, and shape retainability, without deteriorating flavor and texture required for the whipping cream, utilizing a nutrient-rich soybean processed food.

The inventors of the present invention use a tofu puree as a soybean processed food instead of soymilk having a green flavor or the like. Moreover, the inventors found that the contents of the tofu puree, oil and fat, and emulsifier, which are used for producing a whipping cream, influence characteristics, such as decoration suitability, shape retainability, or the like, of the whipping cream. As a result of further investigation based on these findings, the inventors have completed the following whipping cream.

The whipping cream contains: an oil and fat composition in an amount of 20 to 50% by mass; a tofu puree in an amount of 1 to 8% by mass as a solid content of soybeans; and water in an amount of 0 to 73% by mass. The oil and fat composition contains: an oil and fat; and an emulsifier in an amount of 0.5 to 5% by mass with respect to the mass of the oil and fat. The tofu puree contains particles and has the following physical and chemical properties (a) to (d):

(a) viscosity of 20 to 3,000 mPa·s;
(b) dynamic storage modulus of 0.2 to 600 Pa;
(c) dynamic loss modulus of 0.2 to 250 Pa; and
(d) an average particle size of the particles of 2 to 15 μm and a 90% particle size thereof of 35 μm or smaller.

### <Tofu Puree>

The tofu puree satisfying the above-mentioned properties (a) to (d) is available for producing a whipping cream according to the present invention. The term “tofu puree” means a pureed material prepared using soymilk or tofu as a raw material. The tofu puree is preferably prepared by mixing soymilk with a coagulant, heating the mixture to form coagulated soymilk, and then crushing the coagulated soymilk, as circumstantially described below.

### Physical and Chemical Property (a):

Physical and chemical property (a) refers to a condition in which a viscosity is within a range from 20 to 3,000 mPa·s. When the viscosity is within this range, the viscosity of the whipping cream is at an appropriate degree, as a result of which the degree of overrun (inclusion of air) at the time of whipping, the decoration suitability, and the shape retainability are improved.

The viscosity of the tofu puree can be adjusted by controlling as appropriate the solid content of soybeans in the soymilk used as a raw material, dispersing and homogenizing conditions for production using a first emulsification dispersion means or a second emulsification dispersion means, or heating conditions, kinds or contents of the coagulant to be used, or the like.

The method for determining the viscosity concerning the property (a) is as follows. After each sample is left still for 24 hours at 10° C., the viscosity thereof is measured using a B-type viscometer (manufactured by TOKIMEC INC., under the trade name of DVL-BII) equipped with a No. 2, No. 3, or No. 4 rotor at a rotation speed of 60 rpm.

### Physical and Chemical Property (b):

Physical and chemical property (b) refers to a condition in which a dynamic storage modulus is within a range from 0.2 to 600 Pa. When the dynamic storage modulus is within this range, the dynamic viscoelasticity of the whipping cream is at an appropriate degree, as a result of which the degree of overrun, the decoration suitability, and the shape retainability are improved, in particular.

The dynamic storage modulus of the tofu puree can be adjusted by controlling as appropriate the solid content of soybeans in the soymilk used as a raw material, dispersing and homogenizing conditions, or heating conditions, at the time of production, kinds or contents of the coagulant to be used, or the like.

The method for determining the dynamic storage modulus concerning the property (b) is as follows. After each sample is left still for 24 hours at 10° C., the dynamic storage modulus thereof is measured using a viscoelasticity measurement apparatus (manufactured by Rheometric Scientific F.E. Ltd., under the trade name of ARES-200FRT) at a frequency of 50 rad/s at 10° C.

### Physical and Chemical Property (c):

Physical and chemical property (c) refers to a condition in which a dynamic loss modulus is within a range from 0.2 to 250 Pa. When the dynamic loss modulus is within this range, the dynamic viscoelasticity of the whipping cream is at an appropriate degree, as a result of which the degree of overrun, the decoration suitability, and the shape retainability are improved, in particular.

The dynamic loss modulus of the tofu puree can be adjusted by controlling as appropriate the solid content of soybeans in the soymilk used as a raw material, dispersing and homogenizing conditions, or heating conditions, at the time of production, kinds or contents of the coagulant to be used, or the like.

The dynamic loss modulus concerning the property (c) can be determined by the same way as that of the property (b).

### Physical and Chemical Property (d):

Physical and chemical property (d) refers to a condition in which an average particle size of particles contained in the tofu puree is within a range from 2 to 15 μm, and a 90% particle size thereof is 35 μm or smaller. When the average particle size is 2 μm or more, the texture, the decoration suitability, and the shape retainability are improved, in particular. When the average particle size is 15 μm or smaller, the texture is improved, in particular. When the 90% particle size is 35 μm or smaller, the texture is improved, in particular. The reason for improving the texture is that the texture is particularly influenced by the content ratio of large particles.

The average particle size refers to a particle size at 50% counted from a smaller size side on a number base in a cumulative particle size distribution. The 90% particle size refers to a particle size at 90% counted from a smaller size side on a number base in a cumulative particle size distribution.

The average particle size of the particles contained in the tofu puree can be adjusted by controlling as appropriate dispersing and homogenizing conditions at the time of production.

The method for determining the average particle size and 90% particle size concerning the property (d) is as follows. After each sample is left still at 10° C. for 24 hours, the average particle size and the 90% particle size thereof are measured using a laser diffraction particle size distribution analyzer (manufactured by Horiba Seisakusyo Co., Ltd., under the trade name of LA-500).

The values defined in the properties (a) to (d) are not always linked to each other. For example, there is a case in which a tofu puree satisfies the property (a), but does not satisfy at least one of the other properties (b) to (d).

According to the present invention, it has been found that each of the viscosity concerning the property (a), the dynamic storage modulus concerning the property (b), the dynamic loss modulus concerning the property (c), and the average particle size and 90% particle size of particles contained in the tofu puree, concerning the property (d), influences the overrun, decoration suitability, shape retainability, and texture, of a whipping cream. The tofu puree satisfying all of the properties (a) to (d) can realize an enhanced degree of overrun, and improved the decoration suitability, shape retainability, and texture, of a whipping cream. Because the contents of the tofu puree, oil and fat, and emulsifier influence these characteristics, these contents are also defined in the present invention, as described below.

The content of the tofu puree satisfying the properties (a) to (d) is preferably 10 to 80% by mass, and more preferably 20 to 50% by mass, with respect to the total mass of a whipping cream. The content of the tofu puree as a solid content of soybeans is 1 to 8% by mass, and preferably 2 to 5% by mass, with respect to the total mass of a whipping cream. It is preferable that the tofu puree be used in a small amount when the oil and fat is contained in a large amount in the whipping cream, while the tofu puree be used in a large amount when the oil and fat is contained in a small amount. By controlling the content of the tofu puree in such a manner, it is possible for the hardness of the whipped cream, whipping properties such as overrun, or the like, and the shape retainability after whipping to be maintained in the best condition.

The solid content of soybeans may be adjusted by adding water to the tofu puree. In this case, the amount of water to be added is within a range from 0 to 73% by mass, preferably from 10 to 50% by mass, with respect to the total mass of a whipping cream.

### <Oil and Fat Composition>

The oil and fat composition contains an oil and fat and an emulsifier, circumstantially described below. The content of the oil and fat composition is 20 to 50% by mass, and preferably 30 to 40% by mass, with respect to the total mass of a whipping cream. When the content of the oil and fat composition is less than 20% by mass, a whipped cream is soft, and thereby decoration using the cream is difficult. In contrast, when the content of the oil and fat exceeds 50% by mass, an appropriate overrun cannot be realized.

### (Oil and Fat)

Examples of the oil and fat include a hydrogenated oil of liquid oil and fat, such as soybean oil, rapeseed oil, or the like, palm oil, coconut oil, milk fat, beef tallow, lard, hydrogenated fish oil, and the like. However, the oil and fat is not limited to these, and any oil and fat which is generally used for producing a whipping cream may be used. These may be used alone or in combination of at least two kinds thereof.

### (Emulsifier)

As the emulsifier, emulsifiers generally used for producing a whipping cream using a milk constituent may be used. Specific examples of the emulsifier include a glycerin fatty acid ester, polyglycerin fatty acid ester, propylene fatty acid ester, sucrose fatty acid ester, lecithin, and the like. However, the emulsifier is not limited to these.

The content of the emulsifier is 0.5 to 5% by mass, and more preferably 1 to 3% by mass, with respect to the mass of the oil and fat. When the content of the emulsifier is less than 0.5% by mass, sufficient emulsification is not realized. In contrast, when the content of the emulsifier exceeds 5% by mass, thickening and gelatinization easily occur.

### <Others>

Additives such as a sweetener, stabilizer, flavoring, or the like may be arbitrarily used, provided that the effects of the present invention are not deteriorated. The total content of the additives (excepting the emulsifier) is preferably 0 to 10% by mass, and more preferably 0 to 0.5% by mass, with respect to the total mass of a whipping cream. Although the additives may be added at the time of mixing the tofu puree with the oil and fat composition, the additives are preferably mixed with the tofu puree before mixing the tofu puree with the oil and fat composition.

The whipping cream according to the present invention may be produced as follows.

### <Production of Tofu Puree>

The tofu puree is preferably produced by the following:

(a) adding a coagulant to soymilk, and holding the mixture at a temperature between 40° C. and 90° C. to obtain coagulated soymilk (hereinafter, referred to as Step (A));
(b) pre-crushing the coagulated soymilk using a first emulsification dispersion means, and then cooling it at a temperature between 10° C. and 35° C. to obtain a pre-crushed material (hereinafter, referred to as Step (B)); and
(c) crushing the precrushed material using a second emulsification dispersion means to particles having an average particle size of 2 to 15 μm and a 90% particle size of 35 μm or smaller (hereinafter, referred to as Step (C)).

In the following, each step will be explained in more detail.

### Step (A):

First, a coagulant is added to soymilk to obtain a mixture, and the mixture is held at a temperature between 40° C. and 90° C. to obtain coagulated soymilk. As the soymilk used as a staring raw material, any soymilk prepared in accordance with conventional methods may be used, and specific examples thereof include soymilk prepared by soaking soybeans in water for 12 hours, grinding the soaked soybeans using a grinder while adding water thereto to obtain a mash, cooking the mash, and removing soy lees using a separator.

If needed, a soy protein such as an isolated soy protein (manufactured by FUJI OIL CO., LTD., under the trademark of NEW FUJIPRO SEH) or the like may be arbitrarily added to the soymilk.

In particular, it becomes easy to satisfy the properties (a) to (d) by adjusting the solid content of soybeans in the soymilk as a starting raw material within a range from 5 to 15% by mass in this step.

As the coagulant, any substances may be used, provided that they are permitted for use as a food additive and capable of coagulating the soymilk. Among them, it is preferable that at least one selected from the group consisting of glucono delta lactone, calcium acetate, calcium gluconate, calcium lactate, calcium sulfate, calcium chloride, and magnesium chloride be used, because immediate coagulation of the soymilk and prevention of an unpleasant taste can be realized.

The content of the coagulant to be added to the soymilk is not particularly limited, provided that coagulation of the soymilk can be realized. In order to satisfy the properties (a) to (d), the content of the coagulant to be added is preferably within a range from 1 to 7% by mass, with respect to the solid content of soybeans in the soymilk.

The soymilk and the coagulant are mixed uniformly so as to homogeneously react these. In the case of a batch process, the soymilk and the coagulant are preferably agitated using any of various agitators. In the case of a continuous process, the soymilk and the coagulant are preferably mixed uniformly by setting the in-line flow rate of the soymilk at 20 ml/second or higher and the addition rate of the coagulant at 0.2 ml/second or higher.

In order to satisfy the properties (a) to (d), coagulated soymilk is formed by holding the mixture of the coagulant and the soymilk at a temperature between 40° C. and 90° C.

Although the holding time depends on the solid content of soybeans in the soymilk as a raw material, and the kind and amount of the coagulant to be added, the holding time is preferably 2 to 60 seconds, and more preferably 2 to 20 seconds.

For example, in the case of the in-line process, the coagulated soymilk can be formed by heating the soymilk preferably at a temperature between 40° C. and 90° C. using a plate heater (such as one manufactured by Morinaga Engineering Co., Ltd., or the like) and flowing the mixture of the soymilk and the coagulant at a constant flux (flow rate) through a holding pipe preferably capable of achieving a holding time of 2 to 60 seconds.

### Step (B):

The coagulated soymilk prepared in Step (A) is pre-crushed using the first emulsification dispersion means, and then the pre-crushed material is cooled at a temperature between 10° C. and 35° C.

Although the first emulsification dispersion means is not particularly limited provided that it can pre-crush the coagulated soymilk, an in-line device, more preferably a shear pump (such as one manufactured by Yasuda Finete or the like) or MILDER (trademark, manufactured by Ebara corporation or the like), is preferably used in view of continuous productivity.

By using such a device, the coagulated soymilk is preferably pre-crushed to particles having an average particle size of 10 to 50 μm. Specifically, when MILDER® is used, the coagulated soymilk can be pre-crushed to particles having an average particle size of 10 to 50 μm by suitably controlling the rotating speed of MILDER® within a range between 3,000 rpm and 15,000 rpm.

Next, the pre-crushed material is cooled at a temperature between 10 and 35° C. In the case of using an in-line device, this cooling can be realized by flowing the pre-crushed material through a plate cooler (such as one manufactured by Morinaga Engineering Co., Ltd., or the like). When the temperature is 35° C. or lower, a favorable tofu puree satisfying the properties (a) to (d) can be produced even if overheating occurs as a result of frictional heat in the subsequent crushing step. When the temperature is 10° C. or higher, the pre-crushed material is sufficiently crushed while preventing an increase of the viscosity thereof, and thereby sufficiently dispersed in the following step using the second emulsification dispersion means.

### Step (C):

The tofu puree satisfying the properties (a) to (d) is produced by crushing the pre-crushed material prepared in Step (B) to particles having an average particle size of 2 to 15 μm and a 90% particle size of 35 μm or smaller using the second emulsification dispersion means.

The second emulsification dispersion means is not particularly limited provided that it can crush particles contained in the pre-crushed material to particles having the defined particle sizes. In view of continuous productivity, an in-line device, more preferably a homogenizer (such as one manufactured by Sanmaru Machinery Co., Ltd., or the like), shear pump (such as one manufactured by Yasuda Finete, or the like), or MILDER (trademark, manufactured by Ebara corporation), is preferably used.

Specifically, when the homogenizer is used for crushing, the crushed material satisfying the above-defined properties can be obtained by suitably controlling the treatment pressure within a range between 2 and 150 MPa. In this case, it is favorable that crushing be performed while cooling so that the temperature thereof be held at a constant temperature or lower, for example, 25° C., and thereby, the tofu puree can be prevented from being heated by the frictional heat.

### (Production of Tofu Puree Using an In-Line Device)

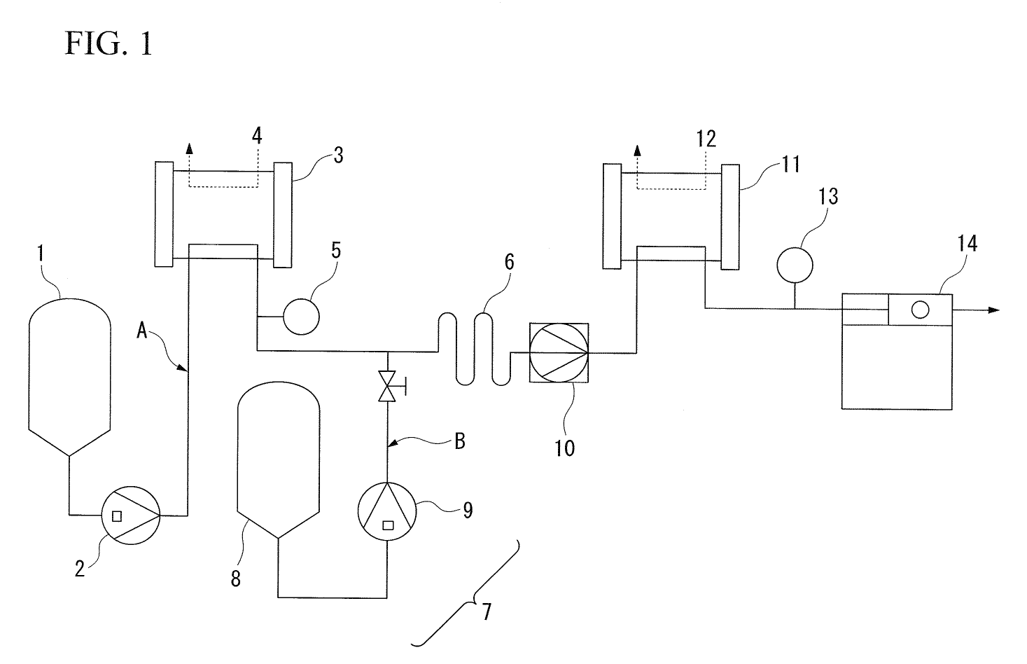

It is preferable that the above-mentioned Steps (A) to (C) be carried out using an in-line device as illustrated in FIG. 1, for example.

As shown in FIG. 1, the device for producing the tofu puree is schematically composed of a system in which a raw material tank 1, a heating means 3, a holding pipe 6, a first emulsification dispersion means 10, a cooling means 11, and a second emulsification dispersion means 14 are connected in this order through a line A, and a coagulant supply means 7 for supplying a coagulant, the coagulant supply means 7 being linked via a line B to the line A at a position between the heating means 3 and the holding pipe 6.

The raw material tank 1 may be any type of tank, provided that it can hold soymilk and is sanitary for food handling.

On the line A, a metering pump 2 equipped with a flux regulator valve is disposed downstream from the raw material tank 1, and the heating means 3 is disposed downstream from the metering pump 2.

The heating means 3 is an apparatus equipped with a heat source 4 for heating a liquid, and examples thereof include a plate heater, a tubular heater, and other heat exchangers. Examples of the heat source 4 include steam, hot water, and the like.

At an outlet of the heating means 3, a temperature controller 5 that automatically controls the temperature of the liquid at the outlet is disposed. The heating means 3 need not be a single apparatus, and may be one capable of heating in stages by a plurality of heat exchangers.

The holding pipe 6 is disposed downstream from the temperature controller 5. The holding pipe 6 holds the mixture of the soymilk and the coagulant for a specific time at a constant temperature to form the coagulated soymilk.

The line B extending from the coagulant supply means 7 for supplying the coagulant is linked to the line A at a position between the heating means 3 and the holding pipe 6.

The coagulant supply means 7 involves a coagulant tank 8 and a metering pump 9 equipped with a flux regulator valve, and is capable of supplying the coagulant in specific amounts to the soymilk that has been heated at a temperature between 40° C. and 90° C. using the heating means.

The first emulsification dispersion means 10 is disposed downstream from the holding pipe 6 in the line A. The first emulsification dispersion means 10 is not particularly limited provided that it can pre-crush the coagulated soymilk, and a shear pump or MILDER® may be preferably used.

The cooling means 11 is disposed downstream from the first emulsification dispersion means 10 in the line A. The cooling means 11 is an apparatus equipped with a refrigerant supply means 12 and is used for cooling a liquid. Examples of the cooling means 11 include a plate cooler, a tubular heater, and other heat exchangers. Examples of refrigerant used in the refrigerant supply means 12 include water, chilled water, and the like.

In the vicinity of an outlet of the cooling means 11 on the line A, a temperature controller 13 that automatically controls the temperature of a liquid at the outlet of the cooling means 11 is disposed. The cooling means 11 need not be a single apparatus, and may be one capable of heating in stages by a plurality of heat exchangers.

The second emulsification dispersion means 14 is disposed downstream from the cooling means 11. The second emulsification dispersion means 14 is not particularly limited provided that it can crush the pre-crushed material to particles having a specific average particle diameter and a specific 90% particle diameter, and examples thereof include a homogenizer, a shear pump, and MILDER®.

It is preferable that each component of the device be sterilely sealed and the production be carried out under sterile conditions, because a large amount of products free from microbial contamination can be manufactured.

In the following, the method for manufacturing the tofu puree using the device will be explained.

First, soymilk is put into the raw material tank 1. Next, the soymilk is supplied to the heating means 3 by operating the metering pump 2, and the soymilk is heated by operating the heat source 4. The heating temperature of the soymilk is controlled using the temperature controller 5.

Next, the heated soymilk is supplied to the holding pipe 6.

On the other hand, a coagulant is put into the coagulant tank 8. Then, the coagulant is supplied from the line B to the line A linked therewith at the position between the heating means 3 and the holding pipe 6 by operating the metering pump 9. Thus, the soymilk and the coagulant are mixed together at an upstream portion from the holding pipe 6, and the mixture is held at a predetermined temperature inside the holding pipe 6, as a result of which coagulated soymilk is formed (see the above-mentioned Step (A)).

Next, this coagulated soymilk is supplied to the first emulsification dispersion means 10, pre-crushed, supplied to the cooling means 11, and then cooled by operating the refrigerant supply means 12, to obtain a pre-crushed material. The cooling temperature is controlled using the temperature controller 13 disposed downstream from the refrigerant supply means 12 (see the above-mentioned Step (B)).

Next, this pre-crushed material is supplied to the second emulsification dispersion means 14 and crushed to particles satisfying the defined properties, and thus the tofu puree is produced (see the above-mentioned Step (C)).

### <Production of Whipping Cream>

A whipping cream can be produced using the tofu puree prepared as described above. In the following, a preferable method for producing the whipping cream will be explained.

To a tofu puree in an amount of 1 to 8% by mass as a solid content of soybeans with respect to the total mass of a whipping cream, water and optional additives are added, and then heated at a temperature between 60° C. and 80° C. To the resultant, an oil and fat composition prepared by adding an emulsifier to an oil and fat, followed by heating and melting the mixture at a temperature between 60° C. and 80° C., is added. The mixture is agitated for 5 minutes at 10,000 rpm using a homomixer to preliminarily emulsify the mixture. Then, the resultant is homogenized using a homogenizer, and then immediately cooled at 10° C. to obtain a whipping cream.

The whipping cream according to the present invention is a novel type of whipping cream having, in addition to a favorable flavor and texture, an excellent whippability, decoration suitability, and shape retainability, which cannot be expected to be realized by conventional products.

Although the reason for this is not clear, it is supposed as follows. The overrun, decoration suitability, shape retainability, flavor, and texture of a whipping cream generally depend on the content of an oil and fat in the whipping cream, the state of fat particles, the particle size distribution of fat particles, the particle size distribution of tofu puree, or the like. These are considered to influence the texture, the state of foam, the state of demulsified and agglomerated oil and fat, and the like, when a whipping cream is whipped. The mechanism of cream-whipping is as follows. Foams are formed by inclusion of air, fat particles are agglomerated to the surface of the foams by partial demulsification accompanying the inclusion of air, and a network is formed by linkage of the agglomerated fat particles, and thus the foams are stabilized. It is supposed that, by adding a coagulant, a soy protein is agglomerated and forms a network of a soy protein, as a result of which the foams are further stabilized, which contributes to improvement of the decoration suitability and shape retainability of the whipping cream.

Moreover, it is supposed that formulation of a specific content ratio of the tofu puree having a fineness and smoothness realized by satisfying the property (d) defining the sharp particle size distribution and having a suitable viscosity, dynamic storage modulus, and dynamic loss modulus as defined by the properties (a) to (c), with a specific content ratio of the oil and fat composition can realize the formation of a conformation excellent in overrun, decoration suitability, and shape retainability, as a result of which a whipping cream with excellent overrun, decoration suitability, and shape retainability, and favorable flavor and texture can be obtained.

### EXAMPLES

Hereinafter, the present invention will be explained in more detail with reference to examples. However, it is apparent that the present invention is not limited to these examples. Also, “%” used in the examples indicates “% by mass” unless otherwise so indicated.

### <Evaluation>

### 1. Measuring properties, concerning the properties (a) to (d), of tofu puree.

The method for measuring the properties, concerning the properties (a) to (d), of tofu puree are described above.

### 2. Evaluation of Characteristics of Whipping Cream

### (1) Measurement of the Degree of Overrun

300 g of a sample was whipped using a mixer (imported by Aicohsha Manufacturing Co., Ltd., under the trademark of KENWOOD CHEF) at 180 rpm and at 6° C. The degree of overrun was calculated as follows:

the degree of overrun (%)=[(X)−(Y)]/(Y)×100

(in the formula, X represents a mass of 100 cm³ of the sample before being whipped, and Y represents a mass of 100 cm³ of each sample collected at an interval of 10 or 15 seconds after being whipped). Then, the maximum degree of overrun was determined. When the sample obtained an overrun of less than 50%, the sample was evaluated as having “no whippability”.

According to the present invention, one with a maximum degree of overrun of 100 to 300% is preferable as a whipping cream. When the maximum degree of overrun is less than 100%, formed foams are unstable and decoration is difficult. In contrast, when the maximum degree of overrun exceeds 300%, formed foams are unstable and rough, and the texture is deteriorated, which are unfavorable.

In Tables 2 to 6, the maximum degree of overrun is indicated

### (2) Measurement of Time Required for Whipping.

A time required for obtaining the maximum degree of overrun by whipping 300 g of a sample using a mixer (imported by Aicohsha Manufacturing Co., Ltd., under the trademark of KENWOOD CHEF) at 180 rpm and at 6° C. was measured.

### (3) Measurement of Penetro Value

The penetro value of the whipping cream sample obtaining the maximum degree of overrun was measured using a penetrometer (manufactured by Nakamura Ika Rika) equipped with a penetrometer cone having an edge angle of 20° and a weight of 12 g.

The penetro value represents the hardness of the whipping cream sample. According to the present invention, it is preferable that the penetro value of a whipping cream be within a range between 150 and 250. When the penetro value is less than 150, the whipping cream is extremely hard and the texture deteriorates. In contrast, when the penetro value exceeds 250, the whipping cream is extremely soft and thereby the decoration is difficult, which is unfavorable.

### (4) Evaluation of Decoration Suitability

A sample was whipped and put into a pastry bag. Then, the flower-forming property upon squeezing the whipped sample through the pastry bag was visually checked and evaluated in accordance with the following criteria.

### A: A sharp edge was formed without causing top-defection, and a smooth texture was obtained.

### B: It was difficult to form a sharp edge and to obtain a smooth texture.

### C: Flower-forming was not realized.

### (5) Evaluation of Shape Retainability

The flower-formed decoration stored at 20° C. overnight was visually checked and evaluated in accordance with the following criteria.

### A: The shape was not lost and favorable

### B: The shape was slightly lost.

### C: The shape was lost.

### (6) Evaluation of Flavor

Each sample was subjected to a sensory test by a panel composed of 20 men and women, ages 20 to 40. Each sample was evaluated by each panelist in accordance with the following criteria.

0 points: Favorable flavor.

1 point: Slightly favorable flavor.

2 points: Slightly unfavorable flavor.

3 points: Unfavorable flavor.

The scores for each sample were averaged, and the averaged value was evaluated in accordance with the following criteria.

Favorable: Less than 0.5 points

Slightly favorable: At least 0.5 points, but less than 1.5 points.

Slightly unfavorable: At least 1.5 points, but less than 2.5 points.

Unfavorable: At least 2.5 points, but less than 3.0 points.

### (7) Evaluation of Texture

Each sample was subjected to a sensory test by a panel composed of 20 men and women, ages 20 to 40. Each sample was evaluated by each panelist in accordance with the following criteria.

0 points: Favorable texture.

1 point: Slightly favorable texture.

2 points: Slightly unfavorable texture.

3 points: Unfavorable texture.

The scores for each sample were averaged, and the averaged value was evaluated in accordance with the following criteria.

Favorable: Less than 0.5 points.

Slightly favorable: At least 0.5 points, but less than 1.5 points.

Slightly unfavorable: At least 1.5 points, but less than 2.5 points.

Unfavorable: At least 2.5 points, but less than 3.0 points.

### <Production of Soymilk and Tofu>

### Reference Example 1

### Example of Production of Soymilk

60 kg of US soybeans (imported by HONDA TRADING CORPORATION) were washed and then were allowed to swell by being immersed in flowing water for 12 hours. The swollen soybeans were supplied together with 170 kg of water to a grinder (manufactured by Nagasawa Kikai Seisakusho Co., Ltd.) and ground so that approximately 220 kg of soybean slurry was obtained. Approximately 220 kg of this soybean slurry was cooked for 4 minutes at 100° C. using a continuous cooking kettle (manufactured by Nagasawa Kikai Seisakusho Co., Ltd.), and separated into soymilk and soy lees using a filter screw press (manufactured by Arai machinery corporation) so that approximately 190 kg of soymilk was obtained. The soybean-solid content of the obtained soymilk was approximately 13%.

### Reference Example 2

### Example of Production of Tofu

60 kg of the same US soybeans as those used in Reference Example 1 were immersed to be swollen. The swollen soybeans were supplied together with 570 kg of water to a grinder and ground so that approximately 620 kg of soybean slurry was obtained. 620 kg of this soybean slurry was cooked for 4 minutes at 100° C. using a continuous cooking kettle, and separated into soymilk and soy lees using a filter screw press so that approximately 600 kg of soymilk was obtained. The soybean-solid content of the obtained soymilk was approximately 4.5%. After 100 kg of the soymilk was cooled at 70 to 75° C., calcium sulfate (manufactured by Tomita Pharmaceutical Co., Ltd.) that had been suspended in lukewarm water was added to the soymilk at a density of 7.8% with respect to the soybean-solid content of the soymilk, and then mixed. The mixture was then left still for 10 minutes. After the obtained coagulated soymilk had been lightly broken down, it was moved to a die case and pressed for 20 minutes so that approximately 80 kg of tofu was obtained. This tofu was then soaked in water and cooled, and was then cut. Thus, firm type tofu (Momen-tofu) was obtained. The water content of the firm type tofu was approximately 87%.

### Test Example 1

### Comparison with Prior Art>

In Test example 1, whipping cream samples according to the present invention were evaluated to demonstrate that they exhibited characteristics superior to those of comparative examples in which prior arts were applied.

Each sample (whipping cream) of examples and comparative examples was produced to evaluate as described below. Properties of tofu purees used in Examples 1-1 and 1-2 and Comparative examples 1-1 to 1-3 are shown in Table 1. Evaluation results of each sample are shown in Table 2.

The samples of the examples were superior to those of Comparative examples 1-1 to 1-4, in which each method disclosed in Patent Documents 1 to 4 was applied, in terms of the decoration suitability and the shape retainability, and the samples of the examples were completely whipped in a short amount of time. Also, the samples of the examples had favorable flavor and texture. Thus, it was confirmed that an excellent whipping cream was obtained by selecting particular materials from conventionally used food materials using tofu or soymilk. Also, it was confirmed that excellent characteristics different from those of whipping creams prepared by a conventionally used soymilk were realized.

Moreover, tests were performed while changing the type of soymilk and type of tofu as appropriate, but approximately the same results were obtained.

### Example 1-1

### (1) Preparation of Tofu Puree

A tofu puree was prepared using a tofu puree manufacturing device shown in FIG. 1.

100 kg of soymilk prepared by the same method as in Reference Example 1 to have a soybean-solid content of 13%, the soymilk being held at 10° C. in the raw material tank 1, was pumped to the heating means 3 using the metering pump 2 equipped with a flux regulator valve (manufactured by NAKAKIN CO., LTD.). The soymilk that flowed into the heating means 3 was heated at 60° C. by hot water of the heat source 4 of which the temperature was controlled by the temperature controller 5 (manufactured by Yokokawa Electric Corporation), and pumped toward the holding pipe 6 at 28 ml/second in a constant flux.

On the other hand, a coagulant (magnesium chloride manufactured by Nichia Chemical Industries) put in the coagulant tank 8 (manufactured by Morinaga Engineering Co., Ltd.) of the coagulant supply means 7 was supplied at 0.4 ml/second in a flux so as to be added in an amount of 4% with respect to the soybean-solid content of the soymilk to the soymilk pumped from the heating means 3 using the metering pump 9 equipped with the flux regulator valve (manufactured by FMI Corporation), and the coagulant and soymilk were uniformly mixed together. The mixture was held for 3 seconds at 60° C. in the holding pipe 6 to produce coagulated soymilk, and the coagulated soymilk was transferred to the first emulsification dispersion means 10 (manufactured by Ebara Seisakusyo Co., Ltd. under the trademark of MILDER).

Next, the coagulated soymilk transferred to the first emulsification dispersion means 10 was immediately pre-crushed to particles having an average particle diameter of 20 μm using MILDER® at a rotation speed of 12,000 rpm, and then transferred to the cooling means 11. The pre-crushed product transferred to the cooling means 11 was cooled by cold water (refrigerant 12) kept at 30° C. by the temperature controller 13 (manufactured by Yokokawa Electric Corporation), and transferred to the second emulsification dispersion means 14 (homogenizer, manufactured by Sanmaru Machinery Co. Ltd.).

The pre-crushed material transferred to the second emulsification dispersion means 14 was crushed to particles having an average particle diameter of 13.4 μm and a 90% particle diameter of 23.1 μm at a treatment pressure of 12 MPa.

The tofu puree thus obtained had a soybean-solid content of 13% with a favorable flavor free from grainy texture.

### (2) Preparation of Whipping Cream Containing Tofu Puree

30.8 kg of the tofu puree prepared in the above-mentioned preparation (1) was mixed with 38.7 kg of water, and the soybean-solid content thereof was adjusted to 4% of a whipping cream. The temperature of the thus prepared aqueous phase was adjusted to 800 C.

On the other hand, 0.5 kg of a sucrose fatty acid ester was added to and dissolved in 30 kg of a hydrogenated palm kernel oil (manufactured by Taiyo-yushi Co. Ltd.) to prepare an oil and fat composition as an oil phase. The temperature of the thus prepared oil phase was adjusted to 80° C.

The aqueous phase was agitated at 8,000 rpm using a homomixer (manufactured by TOKUSYU KIKA KOGYO K.K.), into which the oil phase was gradually added to be preliminarily emulsified. The resultant was homogenized using a homogenizer (manufactured by Sanmaru Machinery Co., Ltd.) at a treatment pressure of 15 MPa, followed by cooling it at 10° C. to obtain a whipping cream containing the tofu puree.

The obtained whipping cream was aged at 5° C. for 18 hours to obtain a sample of Example 1-1.

### Example 1-2

### (1) Preparation of Tofu Puree

A tofu puree was prepared using a tofu puree manufacturing device shown in FIG. 1 in a similar manner to that of Example 1-1, except that some of the manufacturing conditions were changed, as follows.

(i) The heating temperature of the heating means 3 was changed to 80° C.
(ii) The holding temperature of the holding pipe 6 was changed to 80° C.
(iii) The average particle size of particles pre-crushed using MILDER® was 10 μm.
(iv) The treatment pressure of the homogenizer was changed to 3 MPa, and the average particle size of crushed particles was 4.8 μm and the 90% particle size thereof was 8.0 μm.

The tofu puree obtained in Example 1-2 had a soybean-solid content of 13%, and favorable flavor free from grainy texture.

### (2) Preparation of Whipping Cream Containing Tofu Puree

38.5 kg of the tofu puree prepared in the above-mentioned preparation (1) of Example 1-2 was mixed with 41.2 kg of water, and the soybean-solid content thereof was adjusted to 5% of a whipping cream. The temperature of the thus prepared aqueous phase was adjusted to 70° C.

On the other hand, 0.5 kg of a sucrose fatty acid ester was added to and dissolved in 20 kg of a hydrogenated palm kernel oil (manufactured by Taiyo-yushi Co., Ltd.) to prepare an oil and fat composition as an oil phase. The temperature of the thus prepared oil phase was adjusted to 70° C.

The aqueous phase was agitated at 10,000 rpm using a homomixer (manufactured by TOKUSYU KIKA KOGYO K.K.), into which the oil phase was gradually added to be preliminarily emulsified. The resultant was homogenized using a homogenizer (manufactured by Sanmaru Machinery Co., Ltd.) at a treatment pressure of 13 MPa, followed by cooling it at 10° C. to obtain a whipping cream containing the tofu puree. The obtained whipping cream was aged at 5° C. for 18 hours to obtain a sample of Example 1-2.

### Comparative Example 1-1

A whipping cream was prepared as a sample in accordance with a method similar to that of Example 1-1, except that a tofu paste prepared by processing the firm type tofu obtained in Reference Example 2 into a paste using a silent cutter (as disclosed in Example 1 of Patent Document 2) was used instead of the tofu puree.

### Comparative Example 1-2

A whipping cream was prepared as a sample in accordance with a method similar to that of Example 1-1, except that a tofu paste prepared as described below was used instead of the tofu puree.

4.4 g of a glucono delta lactone was added as a coagulant to 2 kg of the soymilk prepared in Reference Example 1, and left still for approximately 30 minutes at 80° C. to coagulate the soymilk. The thus obtained coagulated soymilk was pressed for 30 minutes at a pressure between 0.2 kg/cm² and 1.0 kg/cm² using a press to dehydrate it until the moisture content thereof was 73%. Then, the resultant was processed into a paste using a high-speed cutter to obtain the tofu paste (as disclosed in Example 1 of Patent Document 3).

### Comparative Example 1-3

A whipping cream was prepared as a sample in accordance with a method similar to that of Example 1-1, except that a tofu paste prepared as described below was used instead of the tofu puree.

A coagulant (composed of 2.5 g of calcium chloride, 1.5 g of magnesium chloride, and 3.5 g of citric acid) was dissolved in 17.5 g of water, and added to 5 kg of the soymilk prepared in Reference Example 1, the temperature of the soymilk being held at 80° C. The mixture was held at 80° C. for 5 seconds to obtain coagulated soymilk. The coagulated soymilk was processed into a paste using a homogenizer to obtain the tofu paste (as disclosed in Patent Document 4).

### Comparative Example 14

A whipping cream as disclosed in Example 1 of Patent Document 1 was prepared as a sample in accordance with the following procedure.

An aqueous phase was prepared by adding 1.75 kg of water to 0.45 kg of the soymilk prepared in Reference Example 1 and then adjusting the soybean-nonfat solid content thereof to 2%, followed by adding 4 g of sodium hexametaphosphate to the mixture. The temperature of the aqueous phase was held at 70° C.

On the other hand, an oil phase was prepared by melting 1.8 kg of an oil and fat composed of 75% of a hydrogenated rapeseed oil and 25% of a hydrogenated coconut oil, and heating it at 75° C., followed by adding 12.6 g of lecithin and 7.2 of sucrose fatty acid ester to the heated oil and fat to be melted therein.

The aqueous phase and the oil phase were mixed and emulsified, and then homogenized twice using a homogenizer. Then, the resultant was sterilized at 75° C. for 30 minutes, followed by cooling it at 5° C. to obtain a soymilk whipping cream. This whipping cream was aged at 5° C. for 24 hours to obtain a sample of Comparative Example 1-4.

TABLE 1

| | | | Comparative | | |
|---|---|---|---|---|---|
| | Example | | Example | | |
| | 1-1 | 1-2 | 1-1 | 1-2 | 1-3 |
| (a) Viscosity (mPa · s) | 1100 | 233 | 5010 | 7200 | 430 |
| (b) Dynamic storage modulus | 14.5 | 1.5 | 3700 | 3850.4 | 1.9 |
| (Pa) | | | | | |
| (c) Dynamic loss modulus | 8.7 | 1.1 | 1200.1 | 1400.2 | 1.9 |
| (Pa) | | | | | |
| (d) Average particle size (μm) | 13.4 | 4.8 | 22.4 | 16.2 | 17.4 |
| (e) 90% particle size (μm) | 23.1 | 8.0 | 54.0 | 49.1 | 42.4 |

TABLE 2

| | Example | | Comparative Example | | | |
|---|---|---|---|---|---|---|
| | 1-1 | 1-2 | 1-1 | 1-2 | 1-3 | 1-4 |
| Degree of | 228 | 271 | 88 | 96 | 120 | 214 |
| overrun | | | | | | |
| (%) | | | | | | |
| Whipping time | 105 | 150 | 50 | 45 | 80 | 345 |
| (seconds) | | | | | | |
| Penetro value | 213 | 239 | 125 | 136 | 168 | 203 |
| Decoration | A | A | B | B | A | A |
| suitability | | | | | | |
| Shape | A | A | A | A | A | A |
| retainability | | | | | | |
| Flavor | Favorable | Favorable | Slightly | Slightly | Slightly | Slightly |
| | | | unfavorable | unfavorable | unfavorable | unfavorable |
| Texture | Favorable | Favorable | Unfavorable | Unfavorable | Slightly | Favorable |
| | | | | | unfavorable | |

### Test Example 2

### Comparison of Tofu Purees with Different Physical and Chemical Properties

Effects realized by physical and chemical properties properties (a) to (d) were examined.

### (Preparation of Samples)

Tofu purees each having different physical and chemical properties, that is, viscosity, dynamic storage modulus, and dynamic loss elastic modulus, were prepared by a similar method to that of Example 1-1, except that the treatment pressure of the homogenizer was changed as follows. Each property of the tofu purees concerning physical and chemical properties (a) to (d) is shown in Table 3.

### Example 2-1

The treatment pressure of the homogenizer was set at 1 MPa.

### Example 2-2

The treatment pressure of the homogenizer was set at 12 MPa.

### Example 2-3

The treatment pressure of the homogenizer was set at 17 MPa.

### Comparative Example 2-1

The treatment pressure of the homogenizer was set at 0 MPa.

### Comparative Example 2-2

The treatment pressure of the homogenizer was set at 20 MPa.

Next, 5 types of sample were prepared in a similar manner to that of Example 1-1, except that each tofu puree prepared in the examples and comparative examples of Test Example 2 was used instead of the tofu puree of Example 1-1. The samples were evaluated and the results thereof are shown in Table 3.

It is apparent from the results shown in Table 3 that the specific physical and chemical properties give favorable characteristics in terms of whippability, decoration suitability, and shape retainability. Also, the flavor and texture thereof were favorable.

When other tests were carried out in the same way as described above, except that the kind of soymilk, coagulant, or emulsification dispersion means was suitably changed, similar results were obtained.

TABLE 3

| | | | | Comparative | |
|---|---|---|---|---|---|
| | Example | | | Example | |
| | 2-1 | 2-2 | 2-3 | 2-1 | 2-2 |
| (a) Viscosity (mPa · s) | 20 | 1100 | 3000 | 10 | 4000 |
| (b) Dynamic storage modulus | 20 | 14.5 | 600.0 | 0.1 | 647.5 |
| (Pa) | | | | | |
| (c) Dynamic loss modulus | 0.2 | 8.7 | 50.0 | 0.1 | 258.6 |
| (Pa) | | | | | |
| (d) Average particle size | 2.0 | 13.4 | 15.0 | 1.0 | 21.2 |
| (μm) | | | | | |
| (e) 90% particle size | 15.3 | 23.1 | 35.0 | 10.2 | 38.5 |
| (μm) | | | | | |
| Degree of overrun (%) | 263 | 228 | 143 | 284 | 108 |
| Whipping time (seconds) | 225 | 105 | 65 | 330 | 45 |
| Penetro value | 220 | 213 | 183 | 243 | 135 |
| Decoration suitability | A | A | A | A | B |
| Shape retainability | A | A | A | B | B |
| Flavor | Favorable | Favorable | Favorable | Slightly | Favorable |
| | | | | favorable | |
| Texture | Favorable | Favorable | Favorable | Slightly | Slightly |
| | | | | unfavorable | unfavorable |

### Test Example 3

### Comparison of Whipping Creams with Different Contents of Tofu Puree or Oil and Fat Composition

Test Example 3 was carried out to examine the influence of the contents of the tofu puree or the oil and fat composition on characteristics of samples (whipping creams).

Eleven types of samples were each prepared in a similar manner to that of Example 1-1, except that the content of the tofu puree as the soybean-solid content was varied within a range from 0.5 to 9%, or the content of the oil and fat composition was varied within a range from 10 to 60%, with respect to the total mass of each sample, as shown in Tables 4 and 5. The characteristics of the samples were evaluated and results thereof are shown in Tables 4 and 5.

It is apparent from the results shown in Tables 4 and 5 that formulation of 1 to 8% by mass of a soybean-solid content of the tofu puree with 20 to 50% by mass of the oil and fat composition is required for obtaining whipping cream samples having an excellent whippability, decoration suitability, and shape retainability, together with favorable flavor and texture. Moreover, it was confirmed that a favorable whipping cream was obtained even if the content of the oil and fat composition was 20%, and thus a whipping cream with a fat content lower than that of a whipping cream using soymilk disclosed in Patent Document 1 was obtained.

When other tests were carried out in the same way as described above, except that the kind of soymilk, coagulant, emulsification dispersion means, or oil and fat was suitably changed, similar results were obtained.

TABLE 4

| | Example | | |
|---|---|---|---|
| | 3-1 | 3-2 | 3-3 |
| Soybean-solid content (%) | 8 | 4 | 1 |
| Oil and fat composition (%) | 20 | 30 | 50 |
| Degree of overrun (%) | 161 | 231 | 120 |
| Whipping time (seconds) | 285 | 105 | 60 |
| Penetro value | 165 | 213 | 177 |
| Decoration suitability | A | A | A |
| Shape retainability | A | A | A |
| Flavor | Favorable | Favorable | Favorable |
| Texture | Favorable | Favorable | Favorable |

TABLE 5

| | Comparative Example | | | | | | | |
|---|---|---|---|---|---|---|---|---|
| | 3-1 | 3-2 | 3-3 | 3-4 | 3-5 | 3-6 | 3-7 | 3-8 |
| Soybean-solid | 9.0 | 4.0 | 0.5 | 6.0 | 4.0 | 0.5 | 9 | 0.5 |
| content | | | | | | | | |
| (%) | | | | | | | | |
| Oil and fat | 10 | 10 | 10 | 60 | 60 | 60 | 30 | 30 |
| composition | | | | | | | | |
| (%) | | | | | | | | |
| Overrun | 152 | 231 | Unwhippable | Unwhippable | 63 | 88 | 136 | 220 |
| (%) | | | | | | | | |
| Whipping time | 780 | 1200 | — | — | 55 | 24 | 80 | 450 |
| (seconds) | | | | | | | | |
| Penetro | 246 | 346 | — | — | 168 | 170 | 126 | 276 |
| value | | | | | | | | |
| Decoration | A | C | — | — | C | C | B | B |
| suitability | | | | | | | | |
| Shape retention | C | — | — | — | — | — | B | B |
| Flavor | Slightly | Slightly | — | — | Slightly | Slightly | Slightly | Slightly |
| | unfavorable | favorable | | | unfavorable | unfavorable | unfavorable | favorable |
| Texture | Unfavorable | Unfavorable | — | — | Unfavorable | Unfavorable | Unfavorable | Slightly |
| | | | | | | | | unfavorable |

### Test Example 4

### Comparison of Whipping Creams with Different Contents of Emulsifier

Test Example 4 was carried out to examine the influence of the contents of the emulsifier on characteristics of samples (whipping creams).

Five types of samples were each prepared in a similar manner to that of Example 1-1, except that the content of the emulsifier was varied within a range from 0 to 7%, with respect to the total mass of the oil and fat, as shown in Table 6. The characteristics of the samples were evaluated and results thereof are shown in Table 6.

It is apparent from the results shown in Table 6 that formulation of 0.5 to 5% by mass of an emulsifier with respect to the mass of the oil and fat is required for obtaining whipping cream samples having an excellent whippability, decoration suitability, and shape retainability, together with favorable flavor and texture. It was supposed that when the content of the emulsifier was smaller than the lower limit shown above, emulsification was not sufficiently performed, while when the content of the emulsifier was more than the upper limit shown above, the obtained whipping cream was gelatinized, as a result of which the characteristics thereof deteriorated.

When other tests were carried out in the same way as described above, except that the kind of emulsifier was suitably changed, similar results were obtained.

TABLE 6

| | | | | Comparative | |
|---|---|---|---|---|---|
| | Example | | | Example | |
| | 4-1 | 4-2 | 4-3 | 4-1 | 4-2 |
| Content of emulsifier | 0.5 | 3.0 | 5.0 | 0 | 7.0 |
| (% with respect to | | | | | |
| oil and fat) | | | | | |
| Degree of overrun | 165 | 242 | 268 | Unwhippable | 302 |
| (%) | | | | | |
| Whipping time | 150 | 60 | 110 | — | 180 |
| (seconds) | | | | | |
| Penetro value | 202 | 169 | 185 | | 176 |
| Decoration suitability | A | A | A | — | B |
| Shape retainability | A | A | A | — | B |
| Flavor | Favorable | Favorable | Favorable | — | Favorable |
| Texture | Favorable | Favorable | Favorable | — | Slightly |
| | | | | | unfavorable |

As shown above, when a tofu paste was prepared by directly processing a tofu into a paste, or was prepared by coagulating soymilk with a coagulant followed by dehydrating and processing the coagulant into a paste, it exhibited physical and chemical properties exceeding at least one of the upper limits defined in the properties (a) to (d). Such a tofu paste exhibited a grainy and unfavorable texture. When a whipping cream was prepared using such a tofu paste, the whipping cream also exhibited an unfavorable texture, deteriorated overrun, or decoration-unsuitability.

When a tofu paste was prepared without conducting homogenization after adding a coagulant to soymilk, or was prepared by homogenizing using only a homogenizer, the average particle size exceeded 15 μm and the 90% particle size exceeded 35 μm. When a whipping cream was prepared using such a tofu paste, the texture thereof was unfavorable.

When soymilk was directly used to produce a whipping cream, the whipping cream had a green flavor, astringency, beany flavor, or the like, and the flavor thereof was unfavorable.

In contrast, the whipping cream according to the present invention was a novel type of a whipping cream having an excellent whippability, decoration suitability, and shape retainability, together with a favorable texture and flavor, which were not realized by whipping creams of the prior arts.

Thus, according to the present invention, a whipping cream excellent in whippability, decoration suitability, and shape retainability, without deteriorating flavor or texture, such characteristics being required for the whipping cream, can be provided by utilizing a nutrient-rich soybean processed food.

What is claimed is:

1. A whipping cream comprising:
an oil and fat composition in an amount of 20 to 50% by mass;
a tofu puree in an amount of 1 to 8% by mass as a solid content of soybeans; and
water in an amount of 0 to 73% by mass;
wherein the oil and fat composition comprises: an oil and fat; and an emulsifier in an amount of 0.5 to 5% by mass with respect to a mass of the oil and fat, and the tofu puree comprises particles and has physical and chemical properties of:
(a) viscosity of 20 to 3,000 mPa·s;
(b) dynamic storage modulus of 0.2 to 600 Pa;
(c) dynamic loss modulus of 0.2 to 250 Pa; and
(d) an average particle size of the particles of 2 to 15 μm and a 90% particle size thereof of 35 μm or smaller.
